(19) United States
(12) Patent Application Publication
(10) Pub. No.: US 2002/0054140 A1
(43) Pub. Date: May 9, 2002

(54) Graphics interface enabling associations to be made between graphics elements

(75) Inventors: Veronique Daurensan, Antony (FR); Philippe Lachaud, Palaiseau (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 09/859,442

(22) Filed: May 18, 2001

(30) Foreign Application Priority Data
May 22, 2000 (FR) 00 06 500

(51) Int. Cl. G09G 5/00

(52) U.S. Cl. 345/804

(57) ABSTRACT

A method of manipulating a set of graphics elements on display means, in which the behavior of the graphics element is determined by events, wherein:

at least one first interface element or graphics element is associated with a second graphics element; and

on receiving an event, said second graphics element transmits said event to said at least one first interface element or graphics element.

The present invention relates to graphics user interfaces (GUIS) enabling an operator to interact with an information processing system (e.g. a computer). The invention is particularly applicable when the GUI has numerous graphics elements, as can often be the case in supervisory systems.

### BACKGROUND OF THE INVENTION

A user interface can include graphics elements which are represented within a graphics window, in addition to interface elements (windows, buttons, check boxes, . . . ).

In a supervisory system (for example a telecommunications management network (TMN)), it is common to need to display numerous items of information to the user. For example, provision can be made to display one or more graphics elements for each element being supervised by the system (e.g. a symbolic representation of the supervised element together with associated textual information). Insofar as supervised systems are often of large size, it can happen that the screen becomes saturated in graphics elements to such an extent that it becomes difficult to read.

As a general rule, a plurality of graphics elements are associated with one another by some semantic dependency link, for example because they all relate to the same supervised element. Under such circumstances, they are generally manipulated by the user in similar manner by applying identical actions thereto (converting into icons, moving, etc.). Similarly, it is possible to associate a graphics element with an interface element, typically a window.

It is important to observe that in the context of a supervisory system, the operator must react quickly in the event of a failure in the supervised system. Such a failure can lead to discontinuity in the service provided by the supervised system (e.g. making it impossible to use a telecommunications network), or can have even more severe repercussions (e.g. when the system is managing a nuclear power station).

Unfortunately, and in general, the larger the number of graphics or interface elements displayed simultaneously on a screen, the greater the difficulty the user will have in finding pertinent information.

Similarly, if an operator wishes to modify the physical appearance of a graphics element (i.e. move it, shrink it, expand it, transform it into an icon, etc.), the user will generally need to perform the same actions again for each of the graphics or interface elements associated with that user, and that also can overload the user and reduce speed of reaction in the event of a failure.

### OBJECT AND SUMMARY OF THE INVENTION

The object of the invention is thus to provide a method that simplifies the handling of a large number of graphics elements in a graphics interface, by taking account of the dependencies between the interface and graphics elements.

To this end, the invention provides a method of manipulating a set of interface and graphics elements having behavior that is determined by events. The method comprising the following steps:

at least a first interface or graphics element is associated with a second graphics element; and

on an event being received, the second graphics element transmits the event to said interface or graphics element(s).

The invention also provides a graphics interface enabling the method to be implemented, i.e. a graphics interface comprising a set of interface and graphics elements having behavior that is determined by events, wherein each first interface or graphics element possesses association means for associating it with a second graphics element, and wherein the second graphics element possesses means for transmitting the event it receives to said first interface or graphics element with which it is associated.

### BRIEF DESCRIPTION OF THE DRAWING

The invention, its characteristics, and its advantages are described more clearly below in the following description of an implementation given with reference to the accompanying figures;

FIG. 1 shows an example of a graphics interface having a set of graphics elements.

FIG. 2 shows a graphics element.

### MORE DETAILED DESCRIPTION

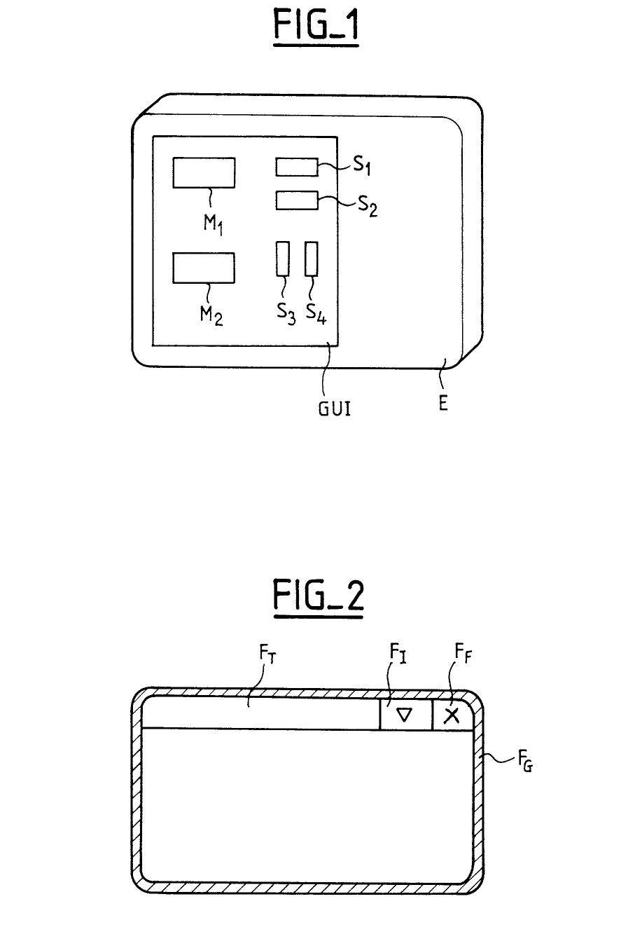

FIG. 1 shows display means E such as a computer screen which is displaying the user interface of a piece of software. This graphics user interface (GUI) comprises a set of interface or graphics elements (S₁, S₂, S₃, S₄, M₁, M₂)

In accordance with the invention, these interface or graphics elements can receive events, e.g. from the user and for example by means of a pointer device such as a mouse. These events can relate to resizing the graphics element, to moving it, to closing it, to converting it into icon form, etc. Another event can arise when the interface or graphics element is hidden by another interface or graphics element or when scrolling an interface element such as a graphics window causes it to come out into a visible zone.

FIG. 2 is a diagram on a larger scale of a particular interface element. It can be seen that it has various means enabling it to receive events. For example, it has an outline FG enabling it to be resized, a title bar F_{T} enabling it to be moved, a first button F_{F} enabling it to be closed, and a second button FI for turning it into an icon.

The behavior of each interface or graphics element is determined by events, in particular by events emanating from the user. More precisely, in the example of FIG. 2, the interface element can be resized, moved, closed, or converted into an icon depending on how the user uses the pointer means to act respectively on the outline F_{G}, the title bar F_{T}, the first button F_{F}, or the second button F_{I}.

In the invention, each graphics element also has association means suitable for establishing dependency links between graphics elements. For example, it is possible to link interface or graphics elements S₁, S₂, S₃, and S₄ to graphics element M₁.

By way of concrete example, this can be useful if the graphics element S₁, S₂, S₃, and S₄ contain information giving further details about information already displayed in briefer form in graphics element M₁.

In the example of a system for managing a network, the graphics element M₁ can represent a subnetwork while the graphics elements S₁, S₂, S₃, and S₄ can represent network elements (i.e. for example, switches) that make up the subnetwork.

In another example, the graphics element M₁ can represent an element of a network in schematic or symbolic manner, whereas the graphics elements S₁, S₂, S₃, and S₄ represent more detailed views of the same network element (e.g. text data).

It will readily be understood by this example that it can be advantageous to manipulate these various graphics elements all in the same way. Typically, if the user tries to close graphics element M₁ (by using its first button F_{F}), then all of the graphics elements that are dependent thereon should also be closed automatically, i.e. all of the graphics elements S₁, S₂, S₃, and S₄ should be closed automatically.

In the same way, if the graphics elements M₁, M₂, S₁, S₂, S₃, and S₄ are contained in a window that possesses so-called “scroll bars” enabling the content of the windows to be scrolled in the display window, it can happen that a graphics element M₁ (for example) moves from being visible to being invisible or vice versa. Under such circumstances, the principle of the invention can be used so as to associate the graphics elements S₁, S₂, S₃, and S₄ with the graphics element M₁ in such a manner that the graphics elements S₁, S₂, S₃, and S₄ vary in the same way as the graphics element M₁.

In preferable manner, the association means are accessible to the user of the user interface while it is in operation, e.g. by using the event mechanism. In other words, the user can at any time decide to associate some graphics element with some other graphics element, or on the contrary can decide to terminate an existing association, by sending an event to the corresponding graphics element.

This can be achieved by adding a button giving access to association means. By way of example, this button can be similar to buttons F_{F} and F_{I} as shown in FIG. 2. After clicking on the button, the user selects a graphics element with which the current graphics element is to be associated. This can be done by means of a pull-down list giving all of the graphics elements, or more simplify by clicking on a graphics element or by any other means that can be imagined.

Once the association has been made, the graphics embodiment in question (S₁, S₂, S₃, or S₄) can send a message (in conventional manner) to the graphics element M₁ with which it is associated to inform it of the new association.

The same principle is implemented when terminating an association.

Once the graphics element M₁ is aware of the associations that concern it, it is capable, on receiving an event, of transmitting the event to the graphics elements S₁, S₂, S₃, and S₄. For this purpose, the graphics element M₁ thus includes memory means enabling it to keep an up to date list of the graphics elements with which it is associated.

On receiving events, the graphics elements S₁, S₂, S₃, and S₄ can either behave in a manner corresponding to the event, or else they can ignore it. This selection can be determined by the user while the graphics interface is in operation. It is preferable for the graphics elements S₁, S₂, S₃, and S₄ to possess means for storing parameters associated with each type of event, so as to determine how they are to behave on receiving an event.

These parameters can be constituted merely by a flag specifying whether or not an event is to be taken into account. In which case, the user can merely specify whether a graphics element is to follow the behavior of the graphics element M₁ with which it is associated, for each type of event (closure, conversion to an icon, moving, etc.).

These parameters can also specify behavior that is more subtle. For example, a distance can be given between two associated graphics elements, with said distance being associated with a “movement” type event. This means for example that when the graphics element M₁ is moved, graphics element S₁ (for example) is not moved unless the distance between them exceeds some distance which is given as a parameter.

In the invention, it is also possible to provide that when a user sends an event of a predetermined type, for example a movement, to a graphics element S₁, S₂, S₃, or S₄, that means that the association with the graphics element is to be terminated. As mentioned above, an association can be terminated by sending a message to the graphics element M₁.

In another implementation, the association is maintained but the parameters are fixed so that the graphics element in question no longer takes account of future elements coming thereto from the graphics element M₁, except perhaps an event of the “close” type.

1/ A method of manipulating a set of interface and graphics elements represented on display means in a graphics window and having behavior that is determined by events, wherein:
at least a first interface or graphics element is associated with a second graphics element; and
on an event being received, said second graphics element transmits said event to said at least one first graphics element or interface element.

2/ A method according to claim 1, in which a user makes an association by sending an event to the graphics element or to the interface element in question.

3/ A method according to claim 1, in which for each of said at least one first element(s), parameters are associated with each type of event in order to determine the behavior of said first element on receiving an event.

4/ A method according to claim 1, in which, when one of said first elements receives an event of a predetermined type, the association with said second graphics element is terminated.

5/ A method according to claim 3, in which, when one of said first elements receives an event of predetermined type, said parameters are fixed so that said first element no longer reacts to future ones of said events transmitted by said second graphics element.

6/ A graphics interface made up of a set of interface or graphics elements having behavior that is determined by events, wherein each first interface or graphics element possesses association means for associating it with a second graphics element, and wherein said second graphics element possesses means for transmitting the event it receives to said first interface or graphics elements with which it is associated.

7/ A graphics interface according to claim 6, in which each first interface or graphics element possesses means for storing parameters associated with each type of event, in order to determine the behavior of said first interface or graphics element on receiving an event.

8/ A graphics interface according to claim 1, in which said association means are accessible to the user during operation of said graphics interface.
